(19) United States
(12) Patent Application Publication
(10) Pub. No.: US 2013/0017052 A1
(43) Pub. Date: Jan. 17, 2013

(54) Apparatus and Method for the Stacking of Stackable Parts

(71) Applicant: Reiner Dörner, Eppingen (DE)

(72) Inventor: Reiner Dörner, Eppingen (DE)

(73) Assignee: SCHULER AUTOMATION GMBH & CO. KG, Hessdorf (DE)

(21) Appl. No.: 13/540,002

(22) Filed: Jul. 2, 2012

(30) Foreign Application Priority Data
Jul. 13, 2011 (EP) EP11005694.2

(51) Int. Cl. B65G 57/10

(52) U.S. Cl. 414/794.4; 414/802

(57) ABSTRACT

An apparatus for the stacking of stackable parts with a conveyor station with at least one conveyor on which the parts may be transported separately, and at least one stacking container in which the parts may be stacked wherein, a stacking device is provided, which takes parts from the conveyor of the conveyor station and stacks them in the stacking container. The stacking device has at least one pair of stacking robots operating independently of one another, wherein the stacking robots alternately or simultaneously take up parts from the conveyor and are so controlled by a control unit that a first and/or second stacking robot takes up at least one part from the conveyor, while simultaneously the second and/or first stacking robot transfers to or stacks in the stacking container used by both stacking robots a part already picked up.

### BACKGROUND OF THE INVENTION

The invention comprises an apparatus for the stacking of stackable parts, in particular pressings, with a conveyor station with at least one conveyor on which the parts may be transported separately, and at least one stacking container in which the parts may be stacked wherein, to transfer the parts between the conveyor station and the stacking container there is provided a stacking device which takes parts from the conveyor of the conveyor station and stacks them in the stacking container.

Stacking devices of this kind have long been known, in particular in the field of automation engineering. For example they are used on press lines for the purpose of taking up pressings formed in a press, which have reached the stacking device via a conveyor station, and stacking them in a stacking container provided for this purpose.

The transfer or forming presses used in press lines have a specific press output, which may be expressed in strokes per minute. So for example 17-stroke transfer presses are known, which are able to press 17 single, double or quadruple parts per minute. It is therefore necessary for the downstream stacking device to have a stacking capacity matched to the press output of the transfer press, and in particular distinctly higher so that the pressings may be stacked in the stacking container provided for this purpose without a backlog of parts.

The problem of the invention is therefore to create an apparatus of the type described above, and a method, with which the number of stackable parts taken up from the conveyor, and able to be stacked in a stacking container provided for this purpose, may be increased as compared with the prior art.

### SUMMARY OF THE INVENTION

This problem is solved by an apparatus for the stacking of stackable parts with the features of the present invention, and a method for the stacking of stackable parts with the features of the present invention. Developments of the invention are described in the dependent claims.

The apparatus according to the invention for the stacking of stackable parts is characterised in that the stacking device has at least one pair of stacking robots containing two stacking robots operating independently of one another, wherein the stacking robots alternately or simultaneously take up parts from the conveyor and are so controlled by a control unit that a first and/or second stacking robot takes up at least one part from the conveyor, while simultaneously the second and/or first stacking robot transfers to or stacks in the stacking container used by both stacking robots a part already picked up, while with simultaneous taking up of parts by the first and second stacking robots, simultaneous stacking in the common stacking container is effected at two different stacking places.

Both stacking robots of a pair of stacking robots therefore stack parts in the same common stacking container. The taking up of parts from the conveyor, which is expediently in the form of a conveyor belt, is effected preferably by both stacking robots of a pair of stacking robots at the same take-up point on the conveyor or at take-up points which are close together. It is possible for the two stacking robots of a pair of stacking robots to operate alternately, i.e. when the first stacking robot takes up a part from the conveyor, the second stacking robot stacks in the stacking container a part already taken up, and vice-versa. In this case, the first and second stacking robots may access the conveyor at the same take-up point. Alternatively it is possible for the two stacking robots of a pair of stacking robots to operate with a time delay so that, when the first stacking robot takes up a part from the conveyor, the second stacking robot transfers to the stacking container a part already taken up. In this case, therefore, it is not take-up and stacking which take place simultaneously, but rather take-up and transfer. It is also possible for the two stacking robots of a pair of stacking robots to take up parts simultaneously from different but closely adjacent take-up points and also simultaneously stack them at two different stacking places, which may also be described as so-called nests, in the stacking container. In the first variant, involving stacking robots operating alternately, the stacking robots may be controlled synchronously. This avoids period of inactivity, i.e. neither of the stacking robots must wait until the other respective stacking robot has completed its operating movement before making its own operating movement. The third variant too, in which two different parts are taken up simultaneously by the two stacking robots, allows periods of inactivity to be avoided. Altogether, the stacking capacity of a stacking device equipped with at least one pair of stacking robots is much increased as compared with the prior art, in which for example two stacking robots spaced relatively far apart from one another are used to stack in different stacking containers. In comparison, in particular the time for onward transfer of the parts to the downstream second stacking robot is dispensed with.

In a development of the invention, several pairs of stacking robots are provided, each assigned a stacking container used jointly by both stacking robots of a specific pair of stacking robots in the stacking of parts. The presence of several pairs of stacking robots allows a further increase in the stacking capacity of the stacking device.

The pairs of stacking robots may be arranged in series along a common conveyor. At the same time, pairs of stacking robots reached first in the direction of conveyance of parts may allow parts for stacking to pass through for downstream pairs of stacking robots. In the case of stacking robots of a pair of stacking robots operating alternately therefore, where two pairs of stacking robots are arranged consecutively, every second part may be allowed through and conveyed on to the downstream pair of stacking robots.

So that the overall dimensions of the stacking device in the direction of conveyance do not become too large, it is expedient to connect pairs of stacking robots in parallel, allocating them to several parallel conveyors of the conveyor station. The parts may therefore be conveyed individually on at least two parallel conveyors of the conveyor section.

In a development of the invention, several stacking containers are assigned to the pair or pairs of stacking robots, with in each case only one being loaded by the two stacking robots of the pair of stacking robots during stacking, while the other stacking containers stand empty in a waiting position. The stacking robots of a pair of stacking robots therefore load up first a common stacking container, which is then transported away after loading. In this case, the two stacking robots of a pair of stacking robots are able to access the further stacking container in waiting position, without periods of inactivity. It is therefore not necessary to wait until the loaded stacking container is replaced by an empty one. The stacking containers assigned to a pair of stacking robots may be arranged one after the other along the conveyor. Alternatively it is possible to arrange the stacking containers left and right of the conveyor.

Expediently the stacking device has a traversing device for traversing the stacking containers between a loading position and a changeover position in which stacking containers filled with stacked parts are replaced by empty containers. The replacement of filled by empty stacking containers may therefore be automated.

In a development of the invention, each of the two stacking robots is in the form of a multi-axis articulated arm robot with at least four swivel axes, of which the first vertical swivel axis makes possible the swivelling movement between the conveyor and the stacking container. The axes, of which there are at least four, make possible accurate positioning of the stacking robots at the parts to be transported on the conveyor and at the stacking containers, so that the parts may then be taken up and placed in the stacking containers by means of a defined lifting movement. Expediently, five six or even seven axis articulated arm robots are used.

It is possible for the stacking device to have a linear guidance fixture for the horizontal linear guidance of the two stacking robots. By this means the two stacking robots may be moved, after completing the loading process at one stacking container, to another stacking container which is in the waiting position. The stacking robots may therefore have at least one additional linear axis, by means of which spaces between the conveyor and the stacking container which do not lie in the swivelling range of the stacking robot concerned may also be bridged through combined swivelling and linear movement. If the stacking containers of a pair of stacking robots are arranged one after the other along the conveyor, then both stacking robots may therefore be traversed for example in the X-direction. A transverse movement of the stacking robots in the Y-direction is however also possible, if the stacking robots are positioned left and right of the conveyor.

It is possible for at least one of the robots to be suspended from a support fixture. Alternatively, though, a standing arrangement of at least one stacking robot is also possible.

The invention also includes a method for the stacking of stackable parts, in particular pressings, which is characterised by the following process steps:
movement of parts placed separately on at least one conveyor
taking up of parts from the conveyor by means of a pair of stacking robots containing two stacking robots operating independently of one another, wherein a first stacking robot takes up a part from the conveyor, while simultaneously a part already taken up is stacked in a stacking container by a second stacking robot operating independently of the first stacking robot, or is transferred to the stacking container, or at least another part is taken up from the conveyor section; in the case of transfer, this is effected by means of a transfer movement which includes swivelling of the second stacking robot
transfer of the part taken up by the first stacking robot to the stacking container, which in the case of stacking or transfer has already been used by the second stacking robot, by means of a transfer movement involving swivelling of the first stacking robot, while at the same time the second stacking robot stacks the other taken-up part in the stacking container, or returns unloaded, or transfers to the stacking container
stacking in the stacking container of the part taken up by the first stacking robot, while at the same time the second stacking robot takes up another part from the conveyor, returns unloaded, or stacks the other taken-up part in the same stacking container used for stacking by the first stacking robot, but at a different stacking point.

### BRIEF DESCRIPTION OF THE DRAWINGS

Preferred embodiments of the invention are shown in the drawing and are explained in detail below. The drawing shows in:

FIG. 1 a side view of part of a press line with transfer press and an apparatus according to the invention for the stacking of stackable parts

FIG. 2 a cross-section through the apparatus of FIG. 1 for the stacking of stackable parts, at right-angles to the direction of conveyance

FIG. 3 a side view of a first embodiment of the apparatus according to the invention

FIG. 4 a top view of the apparatus of FIG. 3

FIG. 5 a side view of a second embodiment of the apparatus according to the invention

FIG. 6 a top view of the apparatus of FIG. 5.

### DETAILED DESCRIPTION OF THE INVENTION

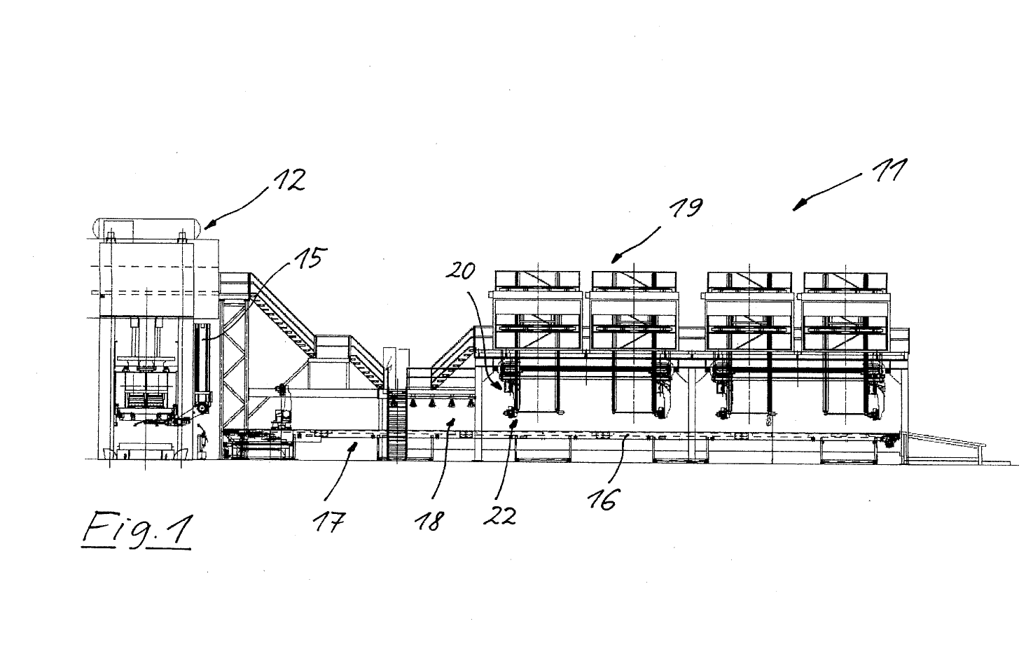

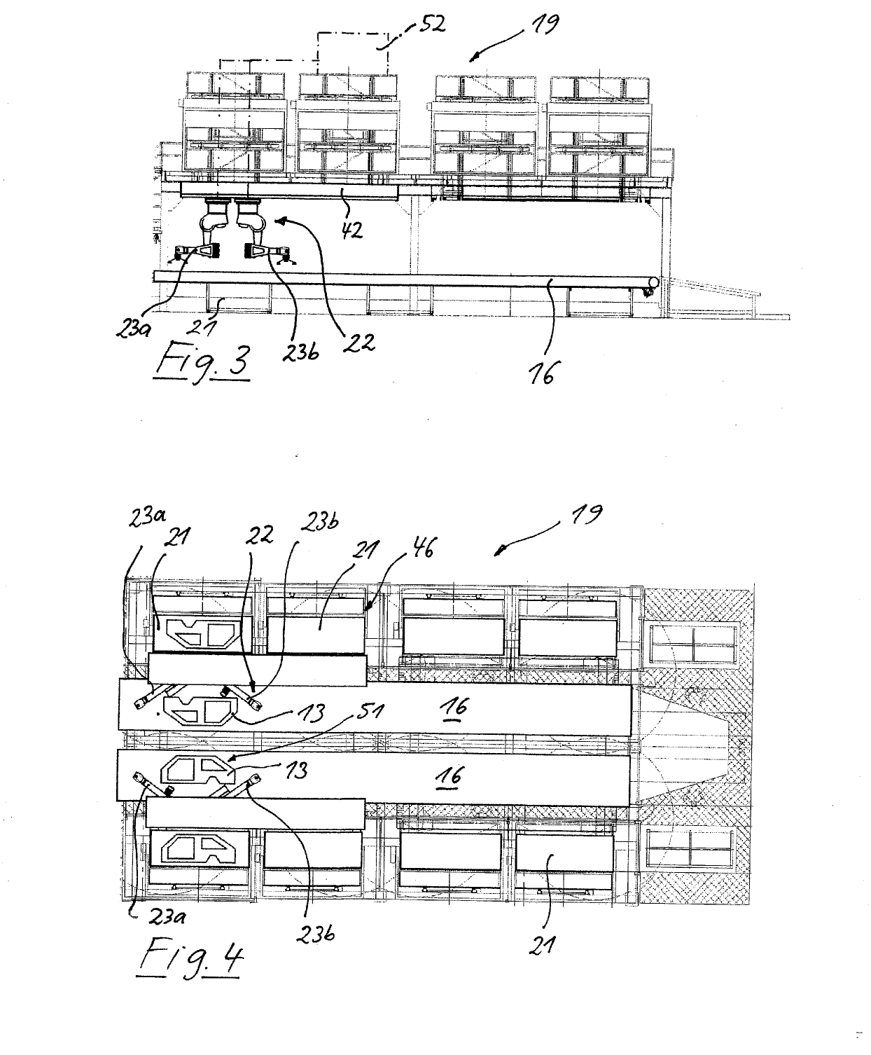

FIG. 1 shows part of a press line 11, as frequently used in automation engineering, for example as part of a pressing plant in the automotive industry. The press line 11 includes a transfer press 12 which forms panel-shaped parts, in particular sheet-metal panels. The press output of such transfer presses 12 is given in strokes per minute. So for example a 17-stroke transfer press 12 is able to make 17 strokes a minute and in so doing to produce 17 individual pressed parts. Individual parts such as side panels of motor vehicles may be pressed, as shown in FIGS. 4 and 6. The transfer press may however also be used to press double parts, i.e. with 17 strokes to produce 17 times two parts 13. Finally it is also possible to produce quadruple parts.

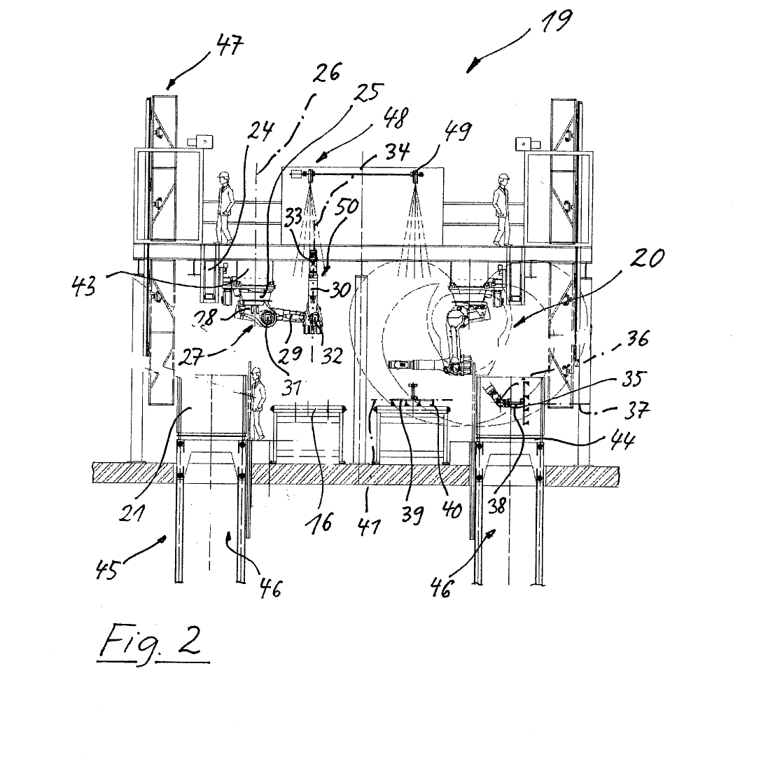

Stackable parts 13 pressed by the transfer press 12 and referred to below for simplicity only as parts 13 are removed from the transfer press 12 by a removal robot 15 and placed on a conveyor 16 of a conveyor station 17 by a swivelling movement, if necessary combined with a linear movement, of the removal robot 15. As shown in particular in FIGS. 2 to 6, the conveyor station 17 has two conveyors 16 running parallel to one another in the form of conveyor belts, on which the parts are placed by the removal robot 15 and separately conveyed onwards.

The parts 13 then pass through an inspection section 18, in which the quality of the forming process carried out by the transfer press 12 is checked. Poor quality parts are separated out here.

After passing through the inspection section 18, the parts 13 reach the apparatus 19 for stacking of the parts 13. The conveyor station 17 with the two conveyors 16 is part of this apparatus 19.

As shown in particular in FIGS. 1 to 6, the apparatus 19 includes a stacking device 20, which takes parts 13 from the conveyor belt and stacks them in stacking containers 21.

As shown in particular in FIGS. 4 to 6, the stacking device 20 has at least one pair of stacking robots 22 with two stacking robots 23a, 23b operating independently of one another and designated as the first stacking robot 23a and the second stacking robot 23b.

FIG. 2 in particular shows that the two stacking robots 23a, 23b are each in the form of multi-axis articulated arm robots, shown here by way of example in a seven-axis version. The two stacking robots 23a, 23b are also suspended from a support unit 24. Each stacking robot 23a, 23b has a robot base 25, on which is pivotably mounted a movement unit 27 capable of swivelling around a first swivel axis 26, vertical in the position of use. The movement unit contains a base-side swivelling section 28 which rests on the robot base 25, pivotable around the vertical first swivel axis 26. The movement unit 27 also contains an articulated arm formed by an upper arm 29 and a lower arm 30. The upper arm 29 of the articulated arm is connected at one end to the swivelling section 28, pivotable around a second swivel axis 31 which is horizontal in the position of use, and at the other end to the facing end of the lower arm 30, pivotable around a horizontal third axis 32.

The movement unit 27 also includes a rotary element 33, mounted at the end of the lower arm 30 opposite the upper arm 29, and rotatable around a fourth axis 34 running in the axial direction of the lower arm 30. Provided on the end of the rotary element 33 opposite the lower arm 30 is a swivelling member 35, which is connected to the rotary element 33 with the ability to swivel around a fifth axis 36 running at right-angles to the fourth axis 34. Attached to the swivelling member 35 is a rotation element (not shown) which may be rotated around a sixth axis 37 running at right-angles to the fifth axis 36, and to which is fixed a support section 38, so that the support section 38 accompanies the rotary movement of the rotation element. The support section 38 preferably carries a lifting device 39 with vacuum suction cups 40. Here the arrangement is such that the support section 38 extends in the direction of the sixth axis 37 away from the swivelling member 35 or from the rotation element resting on the latter, and that the lifting device 39 includes a holding fixture which holds the vacuum suction cups 40 and is connected to the support section 38 so as to be rotatable around a seventh axis 41 aligned at right-angles to the sixth axis 37. With regard to further and closer details of the design and sequence of movements of a seven-axis articulated arm robot of this kind, reference is otherwise made to EP 1 623 773.

The stacking device 20 also has a linear guidance fixture 42 for the horizontal linear guidance of the two stacking robots 23a, 23b in a manner to be described below. The linear guidance fixture 42 also includes the robot base 25, which is like a carriage in form, with linear guidance on guide rails which in turn rest on a rail module 43.

The rail modules 43 are in turn fixed to the portal-like support unit 24. Each of the two stacking robots 23a, 23b therefore has at least one additional axis, namely a traversing axis in the X- and/or the Y-direction.

As shown in particular in FIG. 2, the stacking containers 21 stand next to the conveyors 16 on a platform 44 which is part of the traversing device 45. The traversing device 45 also includes a stacking container lift 46, via which stacking containers 21 loaded with parts 13 may be moved down one floor, preferably through an opening in the floor, where they may be replaced by unloaded stacking containers 21. The stacking device 20 also has a tooling lift 47 with several tooling changeover places, which may as required be moved up or down in the swivelling range of the stacking robots 23a, 23b. This makes possible a tooling changeover through the stacking robot 23a, 23b approaching a tooling changeover point equipped with the desired tool. An example of such tooling is the lifting device 39 with the vacuum suction cups 40. Finally the stacking device 20 also includes a camera system 48 with one or more cameras 49 which are directed on to the conveyors 16 in order to monitor the stacking process.

As also shown in FIG. 2, the stacking robots 23a, 23b may be moved into a parking position 50 in which free access to a particular stacking container 21 is made possible, so that parts from the conveyor 16 may be stacked manually in the stacking container 21.

FIGS. 3 and 4 show a first embodiment of the apparatus 19 according to the invention. Here, two pairs of stacking robots 22 are provided, each with two stacking robots 23a, 23b assigned to one and the other conveyor 16 at the same height along the direction of conveyance. As shown in particular in FIG. 3, the two robot bases 25 of the stacking robots 23a, 23b of a pair of stacking robots 22 are placed relatively close to one another. Although not shown explicitly in FIGS. 3 and 4, the two stacking robots of a pair of stacking robots 22 operate alternately. Thus, the first stacking robot 23a takes up a conveyed part 13, for example an individual part in the form of a motor vehicle side panel, at a take-up position 51, through the vacuum suction cups 40 sucking up the assigned part 13. Synchronously a part 13 is also taken up by the first stacking robot 23a of the other pair of stacking robots 22, i.e. assigned to the other conveyor. At the same time as the part 13 is taken up by the first stacking robot 23a, the second stacking robot 23b places in the stacking container 21 a part 13 already taken up, i.e. it stacks this part in the stacking container 21. Next, the part 13 taken up by the first stacking robot 23a is transferred to the stacking container 21 by means of a swivelling movement around the first swivel axis 26, while at the same time the second stacking robot 23b swivels back unloaded, also around the first swivel axis 26 (intermediate phase). Finally, the part 13 taken up by the first stacking robot 23a is stacked in the stacking container 21, in which the second stacking robot 23b has already stacked its part 13, while simultaneously the second stacking robot 23b takes up a new part from the conveyor 16 at the take-up position 51. These actions also proceed in parallel with the pair of stacking robots 22 of the other conveyor 16. Altogether then, four stacking robots 23a, 23b are active here, which can mean a considerable increase in stacking rates as compared with conventional stacking devices. If the stacking containers 21 for loading jointly by the two stacking robots 23a, 23b are full, then the two stacking robots 23a, 23b of the pair of stacking robots 22 are moved linearly along the linear guidance fixture 42 to the next stacking container 21, which has been in the waiting position during loading of the other stacking container 21. This may be effected by shifting the stacking robots 23a, 23b in the X-direction, in the case of stacking containers 21 positioned one behind the other, or in the Y-direction for stacking containers 21 arranged parallel to one another. The loaded stacking container 21 is then moved down out of the stacking device 20 by the stacking container lift 46, and replaced in the stacking device by an unloaded stacking container 21. All this happens at a point in time when the two stacking robots 23a, 23b of the respective pair of stacking robots 22 are already stacking parts in the rear stacking container 21. There are therefore no periods of inactivity here due to stacking container changeover.

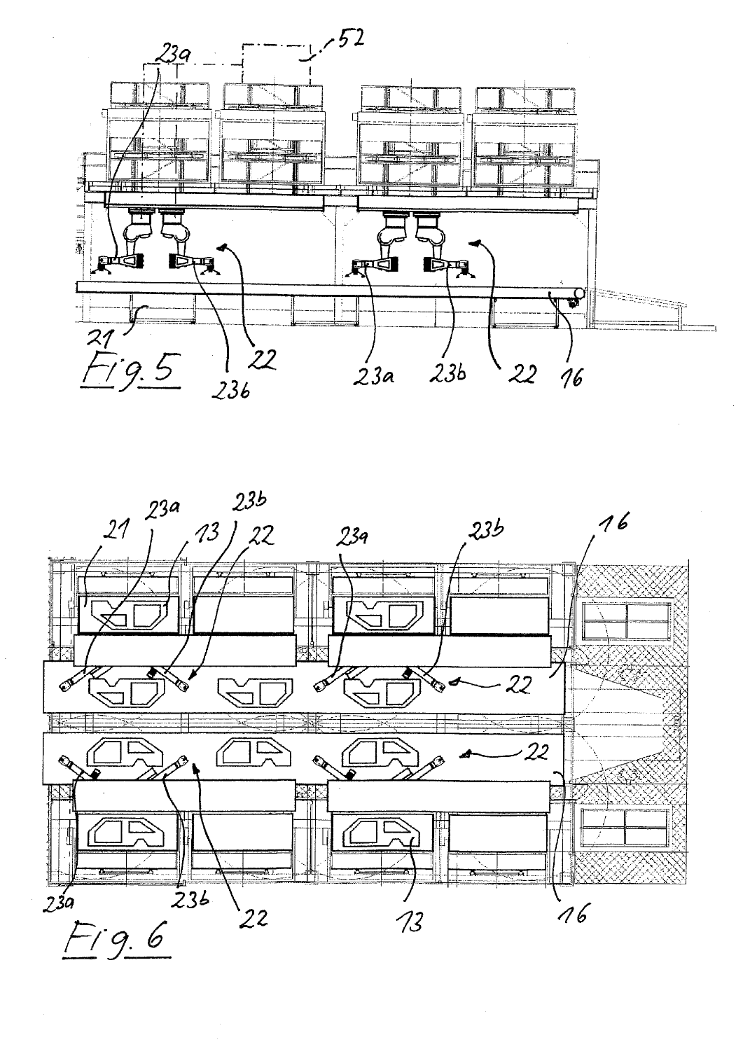

FIGS. 5 and 6 show a second embodiment of the apparatus 19 according to the invention. In contrast to the first embodiment just described, here the number of pairs of stacking robots 22 is doubled, with each two pairs of stacking robots arranged in the direction of conveyance along a common conveyor 16. The mode of operation of the stacking robots 23a, 23b of each pair of stacking robots 22 is identical to that of the first embodiment described above. Different to the first embodiment, though, is the fact that every second part 13 is allowed to pass by the first pair of stacking robots 22 reached in the direction of conveyance, so that it ultimately reaches the rear pair of stacking robots 22 where it is then stacked. Here too the two stacking robots 23a, 23b of a pair of stacking robots 22 stack parts 13 in a common stacking container 21.

1. An apparatus for the stacking of stackable parts with a conveyor station with at least one conveyor on which the parts may be transported separately, and at least one stacking container in which the parts may be stacked, wherein, to transfer the parts between the conveyor station and the stacking container, there is provided a stacking device which takes parts from the conveyor of the conveyor station and stacks them in the stacking container, and wherein the stacking device has at least one pair of stacking robots containing two stacking robots operating independently of one another, wherein the stacking robots alternately or simultaneously take up parts from the conveyor and are so controlled by a control unit that a first and/or second stacking robot takes up at least one part from the conveyor, while simultaneously the second and/or first stacking robot transfers to or stacks in the stacking container used by both stacking robots a part already picked up, while with simultaneous taking up of parts by the first and second stacking robots, simultaneous stacking in the common stacking container is effected at two different stacking places.

2. An apparatus according to claim 1, wherein several pairs of stacking robots are provided, each assigned a stacking container used jointly by both stacking robots of a specific pair of stacking robots in the stacking of parts.

3. An apparatus according to claim 2, wherein the pairs of stacking robots are arranged in series along a common conveyor.

4. An apparatus according to claim 2, wherein the pairs of stacking robots are connected in parallel, allocated to several parallel conveyors of the conveyor station.

5. An apparatus according to claim 1, wherein several stacking containers are assigned to the pair of stacking robots, with in each case only one being loaded by the two stacking robots of the pair of stacking robots during stacking, while the other stacking containers stand empty in a waiting position.

6. An apparatus according to claim 1, wherein each of the two stacking robots of the pair of stacking robots is in the form of a multi-axis articulated arm robot with at least four swivel axes, of which a first vertical swivel axis makes possible a swivelling movement between the conveyor and the stacking container.

7. An apparatus according to claim 1, wherein the stacking device has a traversing device for traversing the stacking containers between a loading position and a changeover position in which stacking containers filled with stacked parts are replaced by empty stacking containers.

8. A method for the stacking of stackable parts comprising the steps of:
movement of parts placed separately on at least one conveyor;
taking up of the parts from the conveyor by means of a pair of stacking robots containing two stacking robots operating independently of one another, wherein a first stacking robot takes up a part from the conveyor, while simultaneously a part already taken up is stacked in a stacking container by a second stacking robot operating independently of the first stacking robot, or is transferred to the stacking container, or at least another part is taken up from the conveyor, wherein, in the case of transfer, this is effected by means of a transfer movement which includes swivelling of the second stacking robot;
transfer of the part taken up by the first stacking robot to the stacking container, which in the case of stacking or transfer has already been used by the second stacking robot, by means of a transfer movement involving swivelling of the first stacking robot, while at the same time the second stacking robot stacks the other taken-up part in the stacking container, or returns unloaded, or transfers to the stacking container; and
stacking in the stacking container of the part taken up by the first stacking robot, while at the same time the second stacking robot takes up another part from the conveyor, returns unloaded, or stacks the other taken-up part in the same stacking container used for stacking by the first stacking robot, but at a different stacking point.

9. A method according to claim 8, wherein the parts are conveyed separately on at least two conveyors of the conveyor station which run parallel to one another.

10. A method according to claim 8, wherein several pairs of stacking robots are provided, each stacking parts in a stacking container used jointly by both stacking robots of the pair of stacking robots.

11. A method according to claim 10, wherein the pairs of stacking robots are arranged in series along a common conveyor, wherein parts reaching first pairs of stacking robots in the direction of conveyance are allowed to pass through for stacking by downstream pairs of stacking robots.

12. A method according to claim 8, wherein at least one of the stacking robots is suspended in operation.

13. A method according to claim 10, wherein the two stacking robots of a pair of stacking robots assigned to a common stacking container may each be moved into a parking position which allows manual stacking of the parts in the stacking container.

14. A method according to claim 10, wherein the two stacking robots of a pair of stacking robots stack parts into the common stacking container until the latter is fully occupied, and then stack parts into the next common stacking container, which is already empty in a waiting position.

15. A method according to claim 14, wherein at least one of the two stacking robots of a pair of stacking robots is able to traverse linearly on changeover to another common stacking container.
